(19) United States
(12) Patent Application Publication
(10) Pub. No.: US 2013/0293868 A1
(43) Pub. Date: Nov. 7, 2013

(54) DETECTION OF FOREIGN OBJECT IN PROXIMTY OF SURGICAL END-EFFECTOR

(71) Applicants: Aleksandra Popovic, New York, NY (US); Emil George Radulescu, Ossining, NY (US); Robert Manzke, Sleepy Hollow, NY (US); Raymond Chan, San Diego, CA (US)

(72) Inventors: Aleksandra Popovic, New York, NY (US); Emil George Radulescu, Ossining, NY (US); Robert Manzke, Sleepy Hollow, NY (US); Raymond Chan, San Diego, CA (US)

(73) Assignee: KONINKLIJKE PHILIPS N.V., EINDHOVEN (NL)

(21) Appl. No.: 13/979,283

(22) PCT Filed: Jan. 25, 2012
(86) PCT No.: PCT/IB2012/050338

§ 371 Date: Jul. 11, 2013

Related U.S. Application Data
(60) Provisional application No. 61/437,314, filed on Jan. 28, 2011.

(51) Int. Cl. G01L 1/24

(52) U.S. Cl. CPC G01L 1/242
USPC 356/35.5

(57) ABSTRACT

An optical detection tool employs a surgical end-effector (30) and an optical fiber (20). In operation, the surgical end-effector (30) is navigated within an anatomical region relative to an object foreign to the anatomical region and the optical fiber (20) generates an encoded optical signal indicative of a strain measurement profile of the optical fiber (20) as the surgical end-effector (30) is navigated within the anatomical region. The optical fiber (20) has a detection segment in a defined spatial relationship with the surgical end-effector (30). The strain measurement profile represents a normal profile in the absence of any measurable contact of the foreign object with the detection segment of the optical fiber (20). Conversely, the strain measurement profile represents an abnormal profile in response to a measurable contact of the foreign object with the detection segment of the optical fiber (20).

The present invention generally relates to a detection of a foreign object in proximity of a surgical end-effector within an anatomical region. The present invention specifically relates to the use of one or more optic fiber “feeler(s)” relative to a surgical end-effector for detecting the foreign object in proximity of a surgical end-effector within an anatomical region.

Penetration of a foreign object in tissue is a common injury during both civilian accidents and military warfare. The most critical injury is a penetrating heart injury. This type of injury may occur because of a direct penetrating injury through the chest and the pericardium or because of embolization of foreign bodies from the venous vasculature. In symptomatic cases, the foreign object in contact with blood flow must be extracted in order to avoid life threatening conditions, such as, for example, embolization of shrapnel into the pulmonary artery or other key vascular beds (e.g., a cerebral circulation via the carotids arteries) that potentially causes vessel rupture or embolization of thrombi which form on the foreign object in contact with blood flow, which in turn potentially causes ischemia and infarction.

One method known in the art for detecting a foreign object is to induce vibrations of ferromagnetic shrapnel to detect the shrapnel with three-dimensional (“3D”) Doppler Ultrasound images. The detected position is used to guide a robotic system to capture the foreign object. However, ultrasonic tracking of the foreign object may provide localization to a level of accuracy limited by the resolution of ultrasound images and the quality of signal footprint associated with the foreign object (i.e., signal-to-noise ratio/carrier-to-noise ratio). This accuracy might be sufficient to guide the robot towards the foreign object. However, once the surgical end-effector of the robot is in close proximity to the targeted foreign object (e.g., <10 mm), a better accuracy is required if the robot system is to deploy a foreign object catching mechanism. In addition, this method works only with ferrous shrapnel.

The present invention provides an optical fiber detection tool for sensing the presence of a foreign object when the foreign object is in close proximity to a surgical end-effector of a surgical robotic system. In contrast to imaging based guidance which may lead a manipulator at a macro-level to the general location of the foreign object, this optical fiber detection tool of the present invention allows for fine-tuned manipulation of the surgical end-effector when the surgical end-effector is in the close vicinity of the foreign object itself. This behavior is enabled by a plurality of optical fiber “feelers” having a defined spatial relationship with the surgical end-effector. These feelers are optically-interrogated to allow for high-sensitivity characterization of feeler deflection/shape and this information may be coupled back to the interventionalist as a visual display and/or audio warning to help in steering of the instrument. This information may also be fed back within a closed feedback control loop for robotic manipulator guidance in a fully automated fashion.

The optical fiber detection tool of the present invention may involve a deflection analysis or a shape reconstruction of an optical fiber by encoding geometric changes into light transmitted into the optical fiber. Specifically, deflection analysis/shape reconstruction of an optical fiber may be performed by making use of variations in an optical refractive index that occur due to introduction of fiber Bragg gratings in the optical fiber or due to natural inhomogeneities in optical refraction arising from the manufacturing process of the optical fiber. A fiber Bragg grating is a short segment of optical fiber that reflects particular wavelengths of light and transmits all others. This is achieved by adding a periodic variation of the refractive index in the fiber core, which generates a wavelength-specific dielectric mirror. A fiber Bragg grating is sensitive to strain, which causes a shift in the Bragg wavelength Δλ_{B} of the fiber Bragg grating in proportion to the magnitude of strain. A primary advantage of using fiber Bragg gratings for distributed sensing is that a large number of deformation optic sensors may be interrogated along a length of a single optical fiber. In similar fashion, fiber deformation may be sensed using a Rayleigh scattering approach that exploits the natural variation in optical refractive index occurring along a length of an optical fiber.

One form of the present invention is an optical detection tool employing a surgical end-effector (e.g., an endoscope, a catheter, etc.) and an optical fiber (e.g., single core or multi-core). In operation, the surgical end-effector is navigated within an anatomical region relative to an object foreign to the anatomical region and the optical fiber generates an encoded optical signal indicative of a strain measurement profile of the optical fiber as the surgical end-effector is navigated within the anatomical region. The optical fiber has a detection segment in a defined spatial relationship with the surgical end-effector, wherein strain measurement profile represents a normal profile in the absence of any measurable contact of the foreign object with the detection segment of the optical fiber and conversely, wherein the strain measurement profile represents an abnormal profile in response to a measurable contact of the foreign object with the detection segment of the optical fiber.

A second form of the present invention is an optical fiber detection method involving a navigation of a surgical end-effector within an anatomical region relative to an object foreign to the anatomical region and a generation of an encoded optical signal indicative of a strain measurement profile of an optical fiber as the surgical end-effector is navigated within the anatomical region. The optical fiber has a detection segment in a defined spatial relationship with the surgical end-effector, wherein the strain measurement profile represents a normal profile in the absence of any measurable contact of the foreign object with the detection segment of the optical fiber and conversely, wherein the strain measurement profile represents an abnormal profile in response to a measurable contact of the foreign object with the detection segment of the optical fiber.

The foregoing forms and other forms of the present invention as well as various features and advantages of the present invention will become further apparent from the following detailed description of various exemplary embodiments of the present invention read in conjunction with the accompanying drawings. The detailed description and drawings are merely illustrative of the present invention rather than limiting, the scope of the present invention being defined by the appended claims and equivalents thereof.

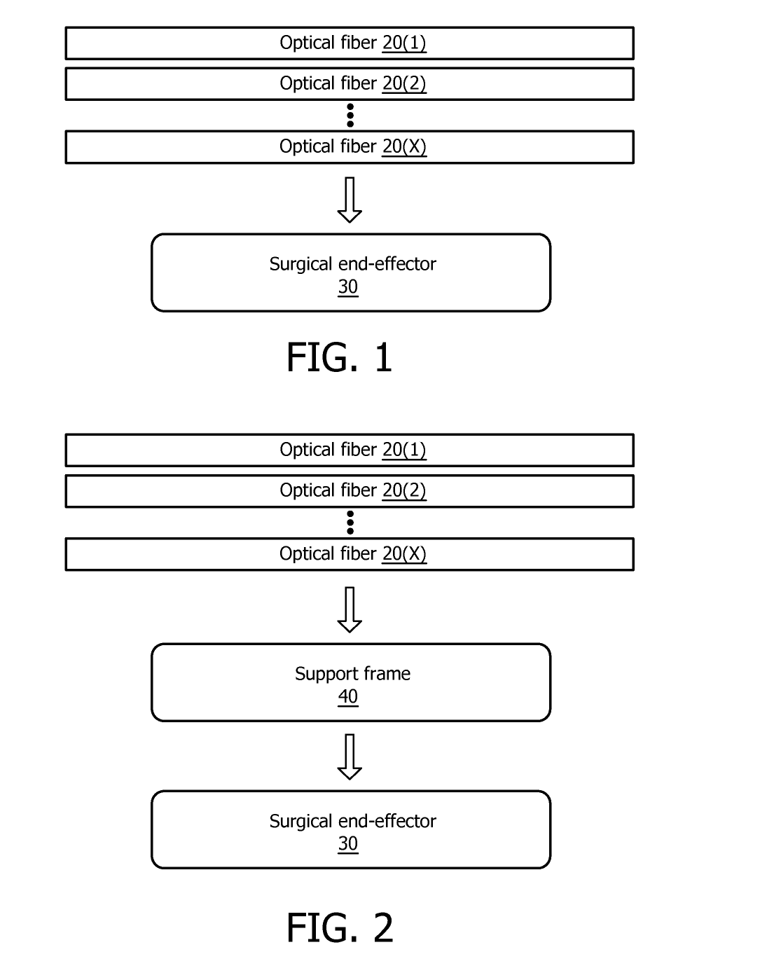

FIG. 1 illustrates a first exemplary embodiment of an optical fiber detection tool in accordance with present invention.

FIG. 2 illustrates a second exemplary embodiment of an optical fiber detection tool in accordance with the present invention.

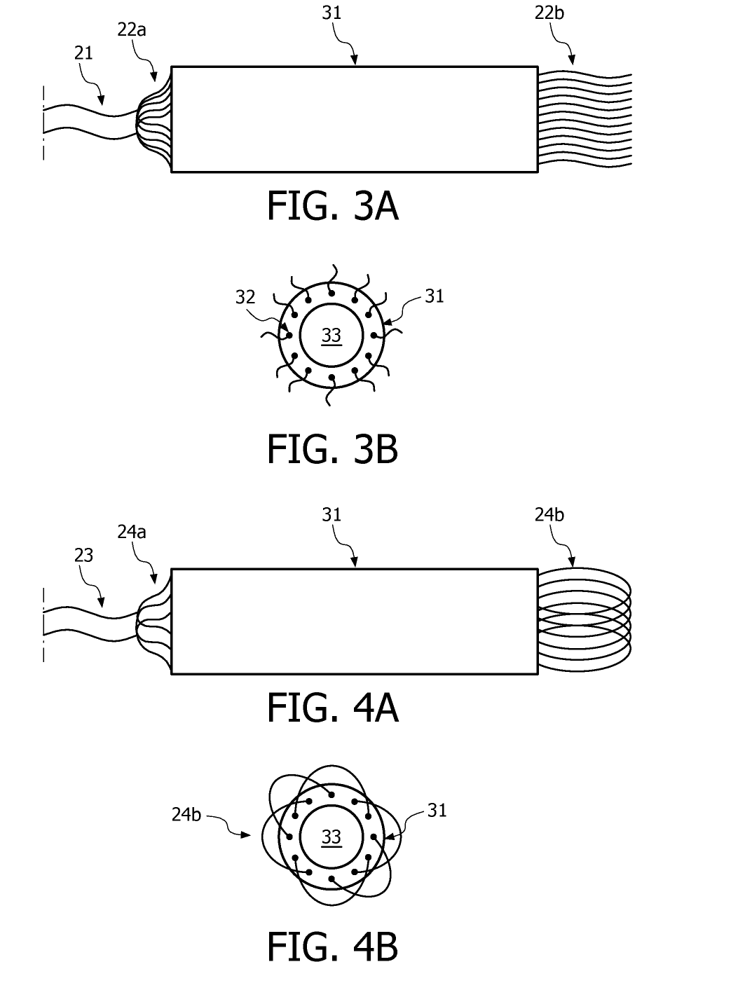

FIGS. 3-5 illustrate exemplary embodiments of the optical fiber detection tool shown in FIG. 1.

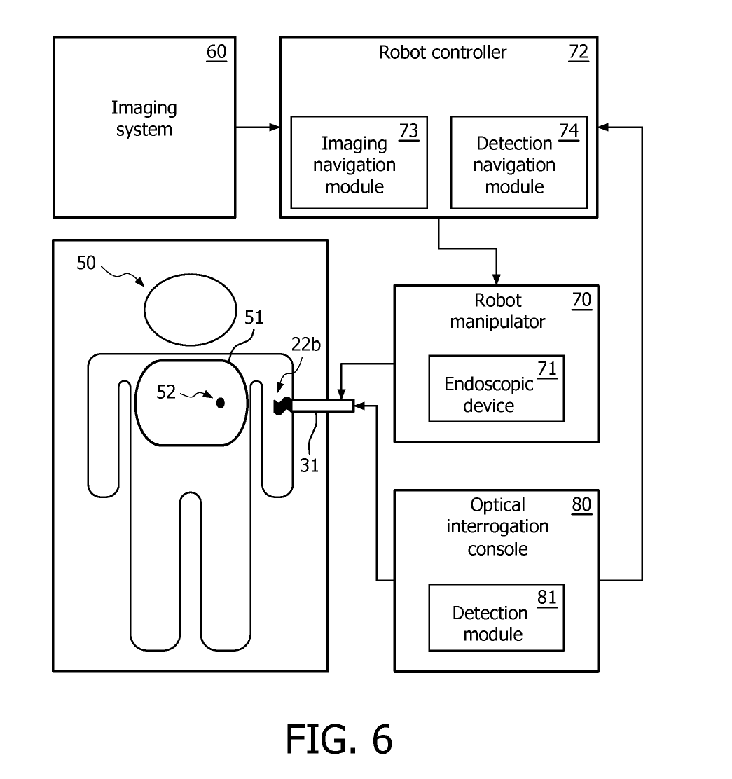

FIG. 6 illustrates an exemplary embodiment of a foreign object detection system in accordance with the present invention.

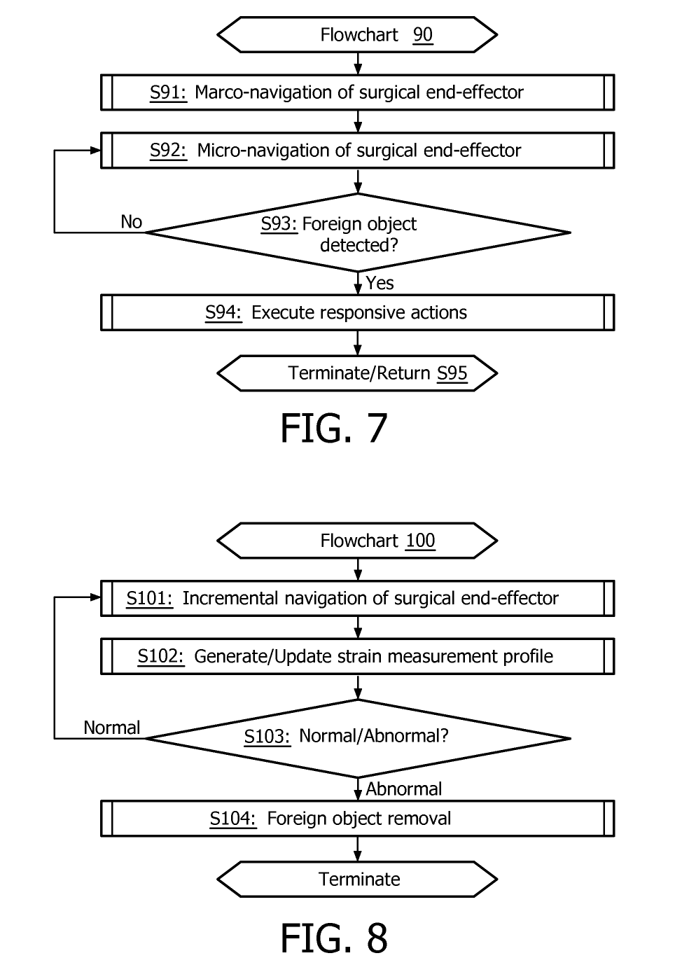

FIG. 7 illustrates a flowchart representative of a foreign object detection method of the present invention.

FIG. 8 illustrates a flowchart representative of a strain measurement profile analysis method of the present invention.

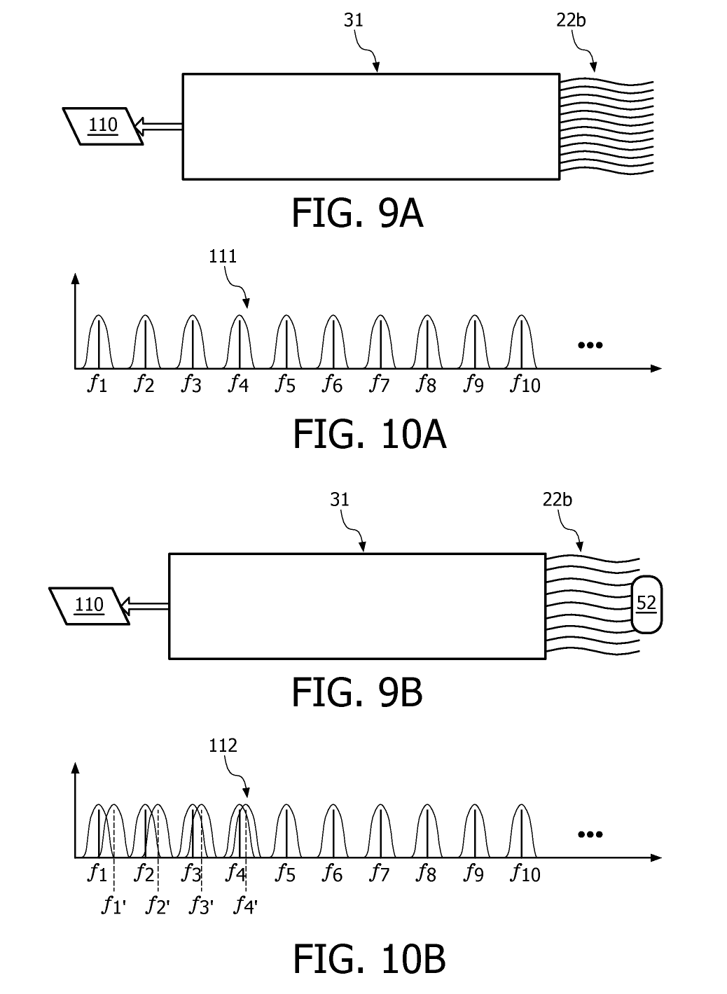

FIG. 9 illustrates exemplary operational modes of the optical fiber tool illustrated in FIG. 3.

FIG. 10 illustrates exemplary encoded optical signal profiles associated with the operational modes of the optical fiber tool shown in FIG. 9.

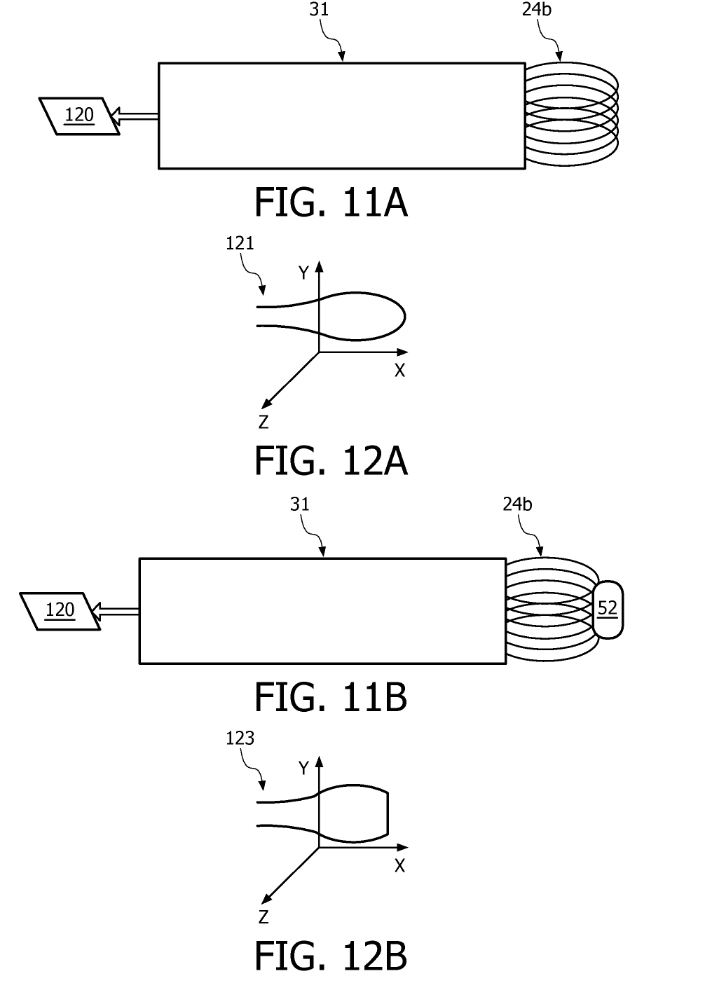

FIG. 11 illustrates exemplary operational modes of the optical fiber tool illustrated in FIG. 4.

FIG. 12 illustrates exemplary encoded optical signal profiles associated with the operational modes of the optical fiber tool shown in FIG. 11.

As shown in FIG. 1, an optical fiber tool of the present invention incorporates an X number of optical fibers 20 into a surgical end-effector 30, where X≧1.

For purposes of the present invention, an optical fiber 20 is broadly defined herein as any article or device structurally configured for transmitting/reflecting light by means of successive internal optical reflections via a deformation optic sensor array with each deformation optic sensor of the array being broadly defined herein as any article structurally configured for reflecting a particular wavelength of light while transmitting all other wavelengths of light whereby the reflection wavelength may be shifted as a function of an external stimulus applied to optical fiber 20. Examples of optical fiber 20 include, but are not limited to, a flexible optically transparent glass or plastic fiber incorporating an array of fiber Bragg gratings integrated along a length of the fiber as known in the art, and a flexible optically transparent glass or plastic fiber having naturally variations in its optic refractive index occurring along a length of the fiber as known in the art (e.g., a Rayleigh scattering based optical fiber). In practice, each optical fiber 20 may include one or more fiber cores as known in the art.

Also for purposes of the present invention, surgical end-effector 30 is broadly defined herein as any article or device structurally configured for implementing a surgical procedure within an anatomical region as controlled by a surgical robotic system as known in the art. Examples of surgical end-effector 30 include, but are not limited to, an endoscope, a catheter, a cannula, a balloon, a filter, a stent or any other surgical tool known in the art that may serve as an end-effector of a surgical robotic system.

In practice, an optical fiber 20 generates an encoded optical signal in the form of a reflection spectrum as known in the art that indicates strain measurements along the length of optical fiber 20. As will be explained in more detail in connection with FIGS. 9 and 10, the strain measurements may be represented by a deflection profile of optical fiber 20 indicating each location and degree of a bend/deflection in optical fiber 20 as known in the art. As will be explained in more detail in connection with FIGS. 11 and 12, the strain measurements may be represented by a shape profile derived from a shape reconstruction of optical fiber 20 via the encoded optical signal as known in the art.

The present invention is premised on incorporating optical fiber 20 with surgical end-effector 30 in a manner that provides a known spatial relationship between a foreign object detection segment of optical fiber 20 and surgical end-effector 30. For purposes of the present invention, the term “foreign object” is broadly defined herein as any object within an anatomical region not deemed to be a conventional object within the anatomical region or designated for removal from the anatomical region, conventional or not. For example, within a chest region, conventional objects include cardiac organs/tissue, and foreign objects may include any type of non-cardiac objects, metallic or non-metallic (e.g., shrapnel).

In one exemplary embodiment of an optical fiber tool as shown in FIGS. 3A and 3B, a tubular end-effector 31 has twelve (12) optical fiber channels 32 and a working channel 33, and a bundle 21 of twelve (12) optical fibers 22 extending through optical fiber channels 32. More particularly, a base segment 22a of each optical fiber 22 extends into a proximal end of one of the optical fiber channels 32 and therethrough, and a foreign object detection segment 22b of each optical fiber 22 extends from a distal end of a corresponding optical fiber channel 32. As such, base segments 22a of optical fibers 22 serve as a basis for establishing a known spatial relationship of foreign object detection segments 22b relative to a distal tip of tubular end-effector 31 whereby only foreign object detection segment 22b may come in contact with object(s), conventional or foreign, as tubular end-effector 31 is robotically navigated within an anatomical region. The resulting encoded optical signal therefore will indicate strain measurements of base segments 22a exclusively due to any strain exerted by tubular end-effector 31 on base segments 22a, and will indicate strain measurements of foreign object detection segments 22b due to object(s), conventional and/or foreign, contacted by one or more foreign object detection segments 22b within the anatomical region, particularly foreign object(s) as will be further explained in connection with the description of FIGS. 9 and 10.

In practice, tubular end-effector 31 may include an inner tube as shown for supporting optical fibers 22 and an outer tube (not shown) that may be translated in a distal direction for covering a segment or an entirety of foreign object detection segments 22b as desired.

In another embodiment of an optical fiber tool as shown in FIGS. 4A and 4B, a bundle 23 of six (6) optical fibers 24 extend through and loop back into optical fiber channels 32. More particularly, a base segment 24a of each optical fiber 24 extends into a proximal end of an optical fiber channel 32 and therethrough, and a foreign object detection segment 24b of each optical fiber 24 extends from a distal end of one of the optical fiber channel 32 and a tip of the foreign object detection segment 24a loops back into another optical fiber channel 32. As such, base segments 24a of optical fibers 24 serve as a basis for establishing a known spatial relationship of foreign object detection segments 24b relative to a distal tip of tubular end-effector 31 whereby only foreign object detection segment 24b may come in contact with object(s), conventional and/or foreign, as tubular end-effector 31 is robotically navigated within an anatomical region. The resulting encoded optical signal therefore will indicate strain measurements of base segments 24a exclusively due to any strain exerted by tubular end-effector 31 on base segments 24a, and will indicate strain measurements of foreign object detection segments 24b due to object(s), conventional and/or foreign, contacted by one or more foreign object detection segments 24b within the anatomical region, particularly foreign object(s) as will be further explained in connection with the description of FIGS. 11 and 12.

In practice, tubular end-effector 31 may include an inner tube as shown for supporting optical fibers 24 an outer tube (not shown) that may be translated in a distal direction for covering a segment or an entirety of foreign object detection segments 24b as desired.

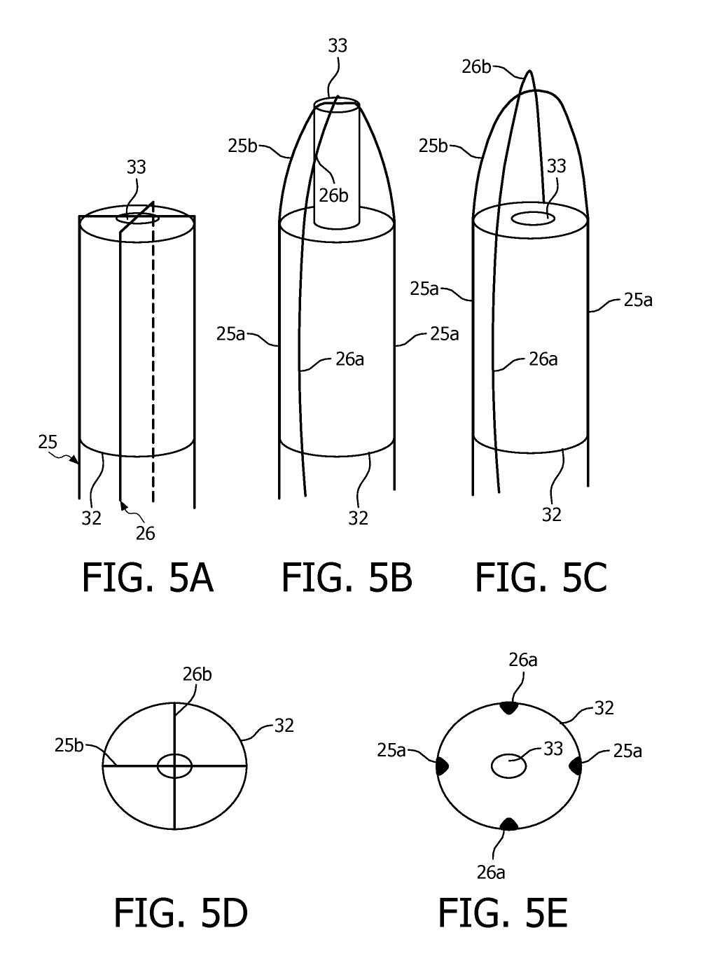

In yet another embodiment of an optical fiber tool as shown in FIGS. 5A-5E, two (2) optical fibers 25 and 26 are embedded within an external surface of a tubular end-effector 32 (e.g., base segments are placed within indentations or registration grooves along the external surface of tubular end-effector 32) and looped over the distal end of tubular end-effector 32. In operation, as best shown in FIGS. 5B and 5C, a pin 33 disposed within a working channel of tubular end-effector 32 is extended a specified distance within a distal direction to define a base segment 25a and a foreign object detection segment 25b of optical fiber 25, and to define a base segment 26a and a foreign object detection segment 26b of optical fiber 26. Thereafter, pin 33 is removed prior to a navigation of tubular end-effector 32 within an anatomical region. During the navigation, base segments 25a and 26b serve as a basis for establishing a known spatial relationship of respective foreign object detection segments 25b and 26b relative to a distal tip of tubular end-effector 32 whereby only foreign object detection segments 25b and 26b may come in contact with object(s), conventional and/or foreign as tubular end-effector 32 is robotically navigated within an anatomical region. The resulting encoded optical signal therefore will indicate strain measurements of based segments 25a and 26a primarily due to any strain exerted by tubular end-effector 31 on base segments 25a and 26a, and will indicate strain measurements of foreign object detection segments 25b and 26b due to object(s), conventional and/or foreign, contacted by one or more foreign object detection segments 25b and 26b within the anatomical region, particularly foreign objects as will be further explained in connection with the description of FIGS. 11 and 12.

In practice, tubular end-effector 32 may include an inner tube as shown for supporting optical fibers 25 and 26 and an outer tube (not shown) that may be translated in a distal direction for covering a segment or an entirety of foreign object detection segments 25b and 26b as desired.

Referring to back to FIG. 1, a foreign object within an anatomical region will typically be significantly more material stiffness than a conventional object within an anatomical region. For example, shrapnel within a chest region will have a significantly more material stiffness than the normal body tissue within the chest region. Nonetheless, the material composition of an optical fiber 20 (e.g., glass or plastic) may not exhibit a desired stiffness to support a required geometric stability/pattern of the detection segments for providing a suitable strain sensitivity to foreign objects as compared to conventional objects. Thus, in practice, surgical end-effector 30 may have a flexible polymer composition for supporting a required geometric stability/pattern for optical fiber(s) 20. Concurrently or alternatively, as shown in FIG. 2, optical fiber(s) 20 may be individually or collectively be embedded within a flexible polymer support frame 30 (e.g., a sheath like covering) for supporting a required geometric stability/pattern for optical fiber(s) 20.

A description of a surgical system will now be described herein to facilitate an understanding of an operational use of an optical fiber detection tool of the present invention.

As shown in FIG. 6, an exemplary embodiment of a foreign object detection system of the present invention employs the optical fiber detection tool of FIG. 3 as well as an imaging system 60, a robot manipulator 70, a robot controller 72 and an optical interrogation console 80.

Imaging system 60 is broadly defined herein as any type of imaging system structurally configured for imaging an anatomical region 51 of a patient 50. Examples of imaging system 60 known in the art include, but are not limited to, an X-ray system, a MRI system, a CT system, an US system or an IVUS system.

Robot manipulator 70 is broadly defined herein as any type of robotic device structurally configured with motorized control of one or more joints for navigating a surgical end-effector within an anatomical region as desired for the particular surgical procedure, such as, for example, a controlled maneuvering of surgical end-effector 31 within anatomical region 50 for retrieving a foreign object 52 as shown. In practice, robot manipulator 61 may have four (4) degrees-of-freedom, such as, for example, a serial robot having joints serially connected with rigid segments, a parallel robot having joints and rigid segments mounted in parallel order (e.g., a Stewart platform known in the art) or any hybrid combination of serial and parallel kinematics. In addition, as shown, an endoscopic device 71 may be integrated with surgical end-effector 31 and robotic manipulator 70 for providing a localized visualization of anatomical region 51 as known in the art.

Robot controller 72 is broadly defined herein as any controller structurally configured for providing robot actuator commands to robot manipulator 70 for navigating surgical end-effector 31 as desired for the surgical procedure, such as, for example, navigating surgical end-effector 31 for retrieving foreign object 52 within anatomical region 50 as shown. To this end, robot controller 72 employs an imaging navigation module 73 for navigating surgical end-effector 31 within an anatomical region 51 either manually or automatically via images generated by imaging system 60 as known in the art and a detection navigation module 62 for navigating surgical end-effector 31 within anatomical region 51 either manually or automatically via foreign objection detection information received from optical interrogation console 80 as will be further explained herein in connection with FIGS. 7 and 8.

Optical interrogation console 80 is broadly defined herein as any console structurally configured for transmitting light through the optical fibers 22 for processing encoded optical signals generated by the successive internal reflections of the transmitted light via the deformation optic sensor array of each optical fiber 22. In one embodiment, optical interrogation console 80 employs an arrangement (not shown) of a coherent optical source, photodetectors, a frequency domain reflectometer and other appropriate electronics/devices as known in the art. For this embodiment, light from the coherent optical source is split between reference optic fiber (not shown) external to surgical end-effector 31 and optical fibers 22 as is typical for optical frequency domain reflectometry. The light for optical fiber 22 is further split using beam splitters to simultaneously illuminate the plurality of optical fibers 22. The frequency domain reflectometer interrogates backscattered light reflected from optical fibers 22 and coherently mixing these reflections with light returning from the reference optic fiber.

For all embodiments, optical interrogation console 80 employs a detection module 81 structurally configured for executing a deflection analysis and/or shape reconstruction of optical fibers 22 directed to localizing the detection segments 22b based on the encoded optical signals in form of digitized interferometric signals. In one embodiment, detection module 81 consists of software, firmware and/or hardware for implementing stages S92 and S93 of flowchart 90 as shown in FIG. 7.

Referring to FIG. 7, flowchart 90 represents a foreign objected detection method of the present invention that will be described herein in context of FIG. 6. At the start, a stage S91 of flowchart 90 encompasses a macro-navigation of surgical end-effector 31 within anatomical region 51 via images generated by imaging device 60 as known in the art. Flowchart 90 proceeds to stage S92 upon surgical end-effector 31 being navigated in proximity of foreign object 52. Endoscopic device 71 may be used during stage S92 to facilitate the navigation of surgical end-effector 32 in proximity of foreign object 52.

Stages S92 and S93 operate in a loop for facilitating a micro-navigation of surgical end-effector 31 within anatomical region until such time optic fibers 22 detect the presence of foreign object 52 whereby responsive action(s) to the detection of the foreign object 52 are executed during a stage S94 of flowchart 90 (e.g., a removal of foreign object 52 or an avoidance of foreign object 52 as surgical end-effector 31 is further navigated within anatomical region 51). In general, the significant difference between the macro-navigation of stage S91 and the micro-navigation loop of stages S92-S93 is the execution of a strain measurement profile analysis method of the present invention as represented by a flowchart 100 shown in FIG. 8.

Referring to FIG. 8, a stage S101 of flowchart 100 encompasses an incremental navigation of surgical end-effector 31 within anatomical region 51 based on facilitating a continual evaluation of a strain measurement profile of each optical fiber 22 during stages S102 and S103 of flowchart 100.

In one embodiment of stages S102 and S103, as shown in FIGS. 9 and 10, a strain measurement profile in the form of a deflection profile is derived from each encoded optical signal 110. Initially, the deflection profile represent a normal profile in the absence of any measurable contact of foreign object 52 with any of the foreign object detection segment 22a of the optical fiber 22, such as, for example a normal frequency profile 111 shown in FIG. 10A in the absence of any measurable contact of foreign object 52 with any of the foreign object detection segments 22a of optical fibers 22 as shown in FIG. 9A. Specifically, normal frequencies profile 111 illustrates nominal frequencies f₁-f₁₀ associated with the first ten (10) sensors (e.g., FBGs) extending in a proximal direction from the distal tip of an optic fiber 22.

The deflection profile is continually updated and one or more of the deflection profiles transition to an abnormal profile upon an exertion of a measurable contact of foreign object 52 with one or more of the foreign object detection segments 22a of optical fibers 22, such as, for example, an abnormal frequency profile 112 shown in FIG. 10B upon an exertion of a measurable contact of foreign object 52 with all of the foreign object detection segment 22a of optical fibers 22 as shown in FIG. 9B. Specifically, abnormal frequency profile 112 illustrates a shift f₁′-f₄′ in nominal frequencies f₁-f₄ that indicate the measurable contact of foreign object 52 with all of the foreign object detection segment 22a of optical fibers 22 as shown in FIG. 9B.

In practice, those having ordinary skill in the art will appreciate the degree of shift in nominal frequencies of optical fibers 22 to establish the transition from a normal frequency profile to an abnormal frequency profile is dependent upon a required measurable contact sensitivity of optical fibers 22 to foreign object 52 as opposed to any conventional objects within anatomical region 51 or a required measurable contact sensitivity of optical fibers 22 to any conventional object(s) designated for removal from anatomical region 51.

In an alternative embodiment of stages S102 and S103 using optical fibers 24 (FIG. 4), as shown in FIGS. 11 and 12, a strain measurement profile in the form of a shape reconstruction profile is derived from each encoded optical signal 120. Initially, the shape reconstruction profiles represent a normal profile in the absence of any measurable contact of foreign object 52 with any of the foreign object detection segment 24a of optical fibers 24, such as, for example a normal profile 121 shown in FIG. 12A in the absence of any measurable contact of foreign object 52 with any of the foreign object detection segments 22a of optical fibers 22 as shown in FIG. 11A. Specifically, normal profile 121 illustrates a pre-designed geometric shape of the foreign object detection segments 24a of optical fibers 24.

The shape reconstruction profile is continually updated and one or more of the shape reconstruction profiles transition to an abnormal profile upon an exertion of a measurable contact of foreign object 52 with one or more of the foreign object detection segments 24a of optical fibers 24, such as, for example, an abnormal profile 122 shown in FIG. 12B upon an exertion of a measurable contact of foreign object 52 with all of the foreign object detection segments 24a of optical fibers 24 as shown in FIG. 11B. Specifically, abnormal profile 122 illustrates a distortion in the pre-designed geometric shape of the foreign object detection segments 24a of optical fibers 24 as in shown in FIG. 9B.

In practice, those having ordinary skill in the art will appreciate the degree of distortion in the pre-designed geometric shape of the foreign object detection segments 24a of optical fibers 24 to establish the transition from a normal profile to an abnormal profile is dependent upon a required measurable contact sensitivity of optical fibers 24 to foreign object 52 as opposed to any conventional objects within anatomical region 51 or a required measurable contact sensitivity of optical fibers 24 to conventional objects designated for removal from anatomical region 51.

Referring back to FIG. 8, stage S104 of flowchart 100 encompasses a removal of foreign object 52 from anatomical region 51. For example, a suitable foreign object retrieval mechanism is inserted through working channel 32 of tubular end-effector 31 to remove foreign object 52 from anatomical region 51. In particular, a position and/or orientation of foreign object 52 relative to the distal end of end-effector 31 may be determined in dependence of the individual strain status of each segment 24b of optical fiber 24.

From the description of FIGS. 1-11, those having ordinary skill in the art will have a further appreciation on how to manufacture and use an optical fiber detection tool in accordance with the present invention for numerous surgical procedures involving a detection and/or removal of a foreign object within an anatomical region. Examples of such foreign bodies include, but are not limited to, shrapnel in the heart, iatrogenic foreign bodies in the heart (e.g., pieces of catheters, needles, broken valve struts that detach from the main device, electrode components that break and embolize into the blood stream), atherosclerotic plaque, blood clots, cardiac tumors detached from the surface, vegetations attached to vascular surfaces that move within the bloodstream, sensitive structures around a surgical instrument.

Those having ordinary skill in the art will further appreciate that, in practice, the exact definitions of a foreign body, a measurable contact sensitivity of foreign object detection segments of the optical fibers, a normal strain measurement profile and an abnormal strain measurement profile are dependent upon how a particular surgical procedure is utilizing a optical fiber detection tool of the present invention.

While various exemplary embodiments of the present invention have been illustrated and described, it will be understood by those skilled in the art that the exemplary embodiments of the present invention as described herein are illustrative, and various changes and modifications may be made and equivalents may be substituted for elements thereof without departing from the true scope of the present invention. For example, although the invention is discussed herein with regard to FBGs, it is understood to include fiber optics for shape sensing or localization generally, including, for example, with or without the presence of FBGs or other optics, sensing or localization from detection of variation in one or more sections in a fiber using back scattering, optical fiber force sensing, fiber location sensors or Rayleigh scattering. In addition, many modifications may be made to adapt the teachings of the present invention without departing from its central scope. Therefore, it is intended that the present invention not be limited to the particular embodiments disclosed as the best mode contemplated for carrying out the present invention, but that the present invention includes all embodiments falling within the scope of the appended claims.

1. An optical fiber detection tool, comprising:
a surgical end-effector operable to be navigated within an anatomical region relative to an object foreign to the anatomical region; and
an optical fiber operable to generate an encoded optical signal indicative of a strain measurement profile of the optical fiber as the surgical end-effector is navigated within the anatomical region,
wherein the optical fiber includes a foreign object detection segment in a defined spatial relationship with the surgical end-effector to facilitate a contact between the fiber object detection segment and the foreign object responsive to the foreign object being in proximity of the surgical end-effector,
wherein the strain measurement profile represents a normal profile in the absence of any measurable contact of the foreign object with the foreign object detection segment of the optical fiber, and
wherein the strain measurement profile represents an abnormal profile in response to a measurable contact of the foreign object with the foreign object detection segment of the optical fiber.

2. The optical fiber detection tool of claim 1, wherein:
the surgical end-effector has a working channel extending between a proximal end and a distal end of the surgical end-effector;
the optical fiber includes a base segment disposed within the working channel with the foreign object detection segment external to the working channel and extending from the base segment at the distal end of the surgical end-effector.

3. The optical fiber detection tool of claim 1, wherein:
the surgical end-effector has a pair of working channels extending between a proximal end and a distal end of the surgical end-effector;
the optical fiber includes a base segment disposed within each working channel with the foreign object detection segment external to the working channels and extending from the base segments in a loop configuration at the distal end of the surgical end-effector.

4. The optical fiber detection tool of claim 1, wherein:
the surgical end-effector has a working channel extending between a proximal end and a distal end of the surgical end-effector;
the optical fiber includes a first base segment and a second base segment disposed along an exterior surface of the surgical end-effector in parallel with the working channel of the surgical end-effector with the foreign object detection segment extending a specified distance from distal end of the surgical end-effector.

5. The optical fiber detection tool of claim 4, further comprising:
a pin operable to be inserted in the working channel of the surgical end-effector for deploying the foreign object detection segment from the distal end of the surgical end-effector.

6. The optical fiber detection tool of claim 1, wherein:
the strain measurement profile is a deflection profile indicative of at least one nominal sensing frequency of the optical fiber;
a normal deflection profile represents an acceptable deflection of the at least one nominal sensing frequency of the optical fiber; and
an abnormal deflection profile represents an unacceptable deflection of the at least one nominal sensing frequency of the optical fiber.

7. The optical fiber detection tool of claim 1, wherein:
the strain measurement profile is a shape reconstruction profile indicative of a pre-defined geometry shape of the optical fiber;
a normal shape reconstruction deflection profile represents an acceptable distortion of the pre-defined geometry shape of the optical fiber; and
an abnormal shape reconstruction profile represents an unacceptable distortion of the pre-defined geometry shape of the optical fiber.

8. An optical fiber detection system, comprising:
an optical fiber detection tool including
a surgical end-effector operable to be navigated within an anatomical region relative to an object foreign to the anatomical region; and
an optical fiber operable to generate an encoded optical signal indicative of a strain measurement profile of the optical fiber as the surgical end-effector is navigated within the anatomical region,
wherein the optical fiber includes a foreign object detection segment in a defined spatial relationship with the surgical end-effector to facilitate a contact between the fiber object detection segment and the foreign object responsive to the foreign object being in proximity of the surgical end-effector,
wherein the strain measurement profile represents a normal profile in the absence of any measurable contact of the foreign object with the foreign object detection segment of the optical fiber, and
wherein the strain measurement profile represents an abnormal profile in response to a measurable contact of the foreign object with the foreign object detection segment of the optical fiber; and
an optical interrogation console in optical communication with the optical fiber for generating and updating the strain measurement profile as the surgical end-effector is navigated within the anatomical region.

9. The optical fiber detection system of claim 8, wherein:
the surgical end-effector has a working channel extending between a proximal end and a distal end of the surgical end-effector;
the optical fiber includes a base segment disposed within the working channel with the foreign object detection segment external to the working channel and extending from the base segment at the distal end of the surgical end-effector.

10. The optical fiber detection system of claim 8, wherein:
the surgical end-effector has a pair of working channels extending between a proximal end and a distal end of the surgical end-effector;
the optical fiber includes a based segment disposed within each working channel with the foreign object detection segment external to the working channels and extending from the base segments in a loop configuration at the distal end of the surgical end-effector.

11. The optical fiber detection system of claim 8, wherein:
the surgical end-effector has a working channel extending between a proximal end and a distal end of the surgical end-effector;
the optical fiber includes a first base segment and a second base segment disposed along an exterior surface of the surgical end-effector in parallel with the working channel of the surgical end-effector with the foreign object detection segment extending a specified distance from distal end of the surgical end-effector.

12. The optical fiber detection system of claim 11, further comprising:
a pin operable to be inserted in the working channel of the surgical end-effector for deploying the foreign object detection segment from the distal end of the surgical end-effector.

13. The optical fiber detection system of claim 8, wherein:
the strain measurement profile is a deflection profile indicative of at least one nominal sensing frequency of the optical fiber;
a normal deflection profile represents an acceptable deflection of the at least one nominal sensing frequency of the optical fiber; and
an abnormal deflection profile represents an unacceptable deflection of the at least one nominal sensing frequency of the optical fiber.

14. The optical fiber detection system of claim 8, wherein:
the strain measurement profile is a shape reconstruction profile indicative of a pre-defined geometry shape of the optical fiber;
a normal shape reconstruction deflection profile represents an acceptable distortion of the pre-defined geometry shape of the optical fiber; and
an abnormal shape reconstruction profile represents an unacceptable distortion of the pre-defined geometry shape of the optical fiber.

15. The optical fiber detection system of claim 8, further comprising:
a robot manipulator for controlling a navigation of the surgical end-effector within the anatomical region; and
a robot controller in communication with the optical interrogation console for operating the robot manipulator in response to the strain measurement profile.

16. (canceled)

17. (canceled)

18. (canceled)

19. (canceled)

20. (canceled)
